(19) United States
(12) Patent Application Publication
(10) Pub. No.: US 2013/0125116 A1
(43) Pub. Date: May 16, 2013

(54) Method and Device for Adjusting Virtual Resource and Computer Readable Storage Medium

(71) Applicants: Kun-Hsing Liu, Magong City (TW); Yen-Wen Huang, New Taipei City (TW); Hui-Kuang Chung, Taipei City (TW); Han-Chao Lee, Taipei City (TW)

(72) Inventors: Kun-Hsing Liu, Magong City (TW); Yen-Wen Huang, New Taipei City (TW); Hui-Kuang Chung, Taipei City (TW); Han-Chao Lee, Taipei City (TW)

(73) Assignee: Institute for Information Industry, Taipei (TW)

(21) Appl. No.: 13/314,789

(22) Filed: Dec. 8, 2011

(30) Foreign Application Priority Data
Nov. 10, 2011 (TW) 100141069

(51) Int. Cl. G06F 9/455

(52) U.S. Cl. 718/1

(57) ABSTRACT

A method for adjusting a virtual resource used in a virtual system is provided. The method comprises the following steps. At least one virtual machine is provided in the virtual system, and the at least one virtual machine has maximum and minimum thresholds of I/O (Input/Output) loading and maximum and minimum thresholds of operation loading. An I/O loading amount and an operation loading amount of the total loading amount of the virtual system are retrieved. The relationship of the I/O loading amount and the maximum and minimum thresholds of I/O loading is determined to adjust the number of the virtual machine, and the relationship of the operation loading amount and the maximum and minimum thresholds of operation loading is determined as well to adjust an unit resource amount of the virtual machine.

### RELATED APPLICATIONS

This application claims priority to Taiwan Application Serial Number 100141069, filed Nov. 10, 2011, which is herein incorporated by reference.

### BACKGROUND

1. Technical Field

The present invention relates to a virtual machine technology. More particularly, the present invention relates to a method and device for adjusting virtual resource adjusting, and a computer readable storage medium.

2. Description of Related Art

In the conventional technology, only one operating system can be executed on one physical machine. The hardware resource of the physical machine thus cannot be fully utilized. In order to improve the efficiency and availability of the hardware resource and applications, a virtualization technology is used to establish a virtual environment for running multiple virtual machines on the physical machine to fully utilize the hardware resource.

In a virtual system, the resource is needed to be adjusted according to the amount of data processed in the system. It is one of the most intuitive manners to adjust the resource of the virtual system through a graphic user interface. In a conventional graphic user interface, the user may adjust the amount of resource through the use of an empty field, a pull down menu or an adjusting bar, in which the empty field is used for inputting a value, the pull down menu is used for providing options, and the adjusting bar is used for adjusting values by moving the bar. However, the user has to type or select the correct values carefully if one of the above methods is used, which is not intuitive. Further, it is time-consuming to type or select the correct values.

Accordingly, it is an issue needed to be resolved by those in this field regarding how to design a system and a method for operating a graphic user interface, and a computer readable storage medium to overcome the aforementioned problems.

### SUMMARY

An aspect of the present disclosure is to provide a method for adjusting virtual resource used in a virtual system. The method comprises the steps outlined below. At least one virtual machine in the virtual system having a maximum I/O load threshold, a minimum I/O load threshold, a maximum operation load threshold and a minimum operation load threshold is provided. An I/O loading amount and an operation loading amount of the total data loading amount of the virtual system are retrieved. A relationship of the I/O loading amount and the maximum I/O load threshold and the minimum I/O load threshold is determined, and a relationship of the operation loading amount and the maximum operation load threshold and the minimum operation load threshold is determined. The number of the virtual machine is adjusted according to the relationship of the I/O loading amount and the maximum I/O load threshold and the minimum I/O load threshold and an unit resource amount of the virtual machine is adjusted according to the relationship of the operation loading amount and the maximum operation load threshold and the minimum operation load threshold.

Another aspect of the present disclosure is to provide a device for adjusting virtual resource used in a virtual system having at least one virtual machine. The device comprises a retrieving module, a determining module and an adjusting module. The retrieving module retrieves an I/O loading amount and an operation loading amount of the total data loading amount of the virtual system. The determining module determines the relationship of the I/O loading amount and a maximum I/O load threshold and a minimum I/O load threshold of the virtual machine and determining the relationship of the operation loading amount and a maximum operation load threshold and a minimum operation load threshold of the virtual machine. The adjusting module adjusts the number of the virtual machine according to the relationship of the I/O loading amount and the maximum I/O load threshold and the minimum I/O load threshold and to adjust an unit resource amount of the virtual machine according to the relationship of the operation loading amount and the maximum operation load threshold and the minimum operation load threshold.

Yet another aspect of the present disclosure is to provide a computer readable storage medium to store a computer program to execute a method for adjusting virtual resource used in a virtual system. The method comprises the following steps. At least one virtual machine in the virtual system having a maximum I/O load threshold, a minimum I/O load threshold, a maximum operation load threshold and a minimum operation load threshold is provided. An I/O loading amount and an operation loading amount of the total data loading amount of the virtual system are retrieved. The relationship of the I/O loading amount and the maximum I/O load threshold and the minimum I/O load threshold is determined and the relationship of the operation loading amount and the maximum operation load threshold and the minimum operation load threshold is determined. The number of the virtual machine is adjusted according to the relationship of the I/O loading amount and the maximum I/O load threshold and the minimum I/O load threshold and an unit resource amount of the virtual machine is adjusted according to the relationship of the operation loading amount and the maximum operation load threshold and the minimum operation load threshold.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a virtual system according to an embodiment of the present disclosure;

FIG. 2 is a block diagram of a device for adjusting virtual resource according to an embodiment of the present disclosure;

FIG. 3 is a flow chart showing a method for adjusting virtual resource according to an embodiment of the present disclosure;

FIG. 4A and FIG. 4B are detail flow charts of the process for determining the relationship of the I/O loading amount and the operation loading amount and the corresponding thresholds according to an embodiment of the present disclosure;

FIG. 5A and FIG. 5B are detail flow charts of the process for adjusting the virtual machines according to an embodiment of the present disclosure; and

FIG. 6 is a graph showing the strategy of the adjustment in the method according to an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

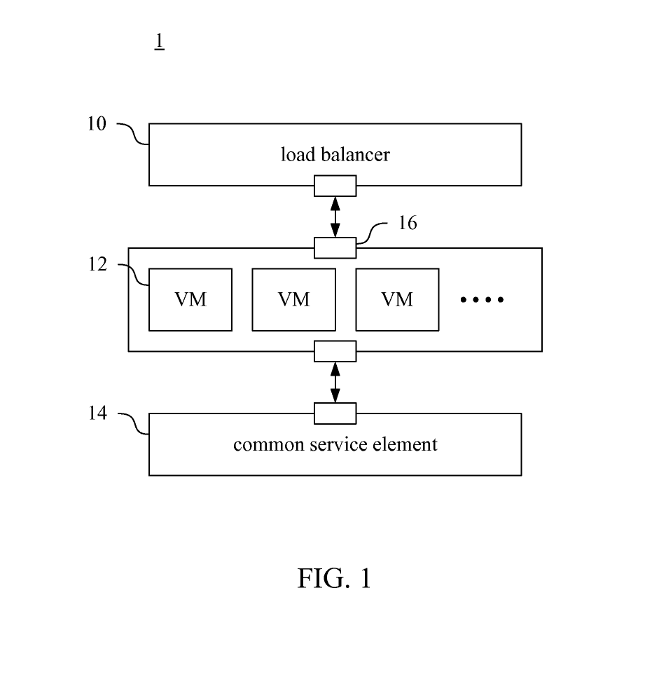

FIG. 1 is a diagram of a virtual system 1 in an embodiment of the present disclosure. In the present embodiment, the virtual system 1 comprises a load balancer 10, at least one virtual machine 12 and a common service element 14. The common service element 14 may be a common storage or a common database.

The virtual system 1 is a virtual environment established on a physical operation device (not shown) for generating a plurality of virtual machines 12 (depicted as VM in FIG. 1) that are able to access the hardware resources of the physical operation device through the virtual technology. For example, the virtual system 1 can be established on a single personal computer to generate virtual machines 12. Different operation systems can be executed in these virtual machines. The desire to run multiple operating systems was the original motivation for creating virtual machines, as the virtual machines allow a single computer to be time shared between several single-tasking operation systems. The data access requests from the network can be processed through the network interface 16 between the load balancer 10 and the virtual machines 12 or through the network interface 16 between the virtual machines 12 and the common service element 14. The load balancer is used for monitoring the load amount of the virtual system 1, distributing the data among the virtual machines 12 and adjusting the virtual machines accordingly. In different embodiments, the load balancer 10 can be implemented by using either a virtual machine or a physical machine.

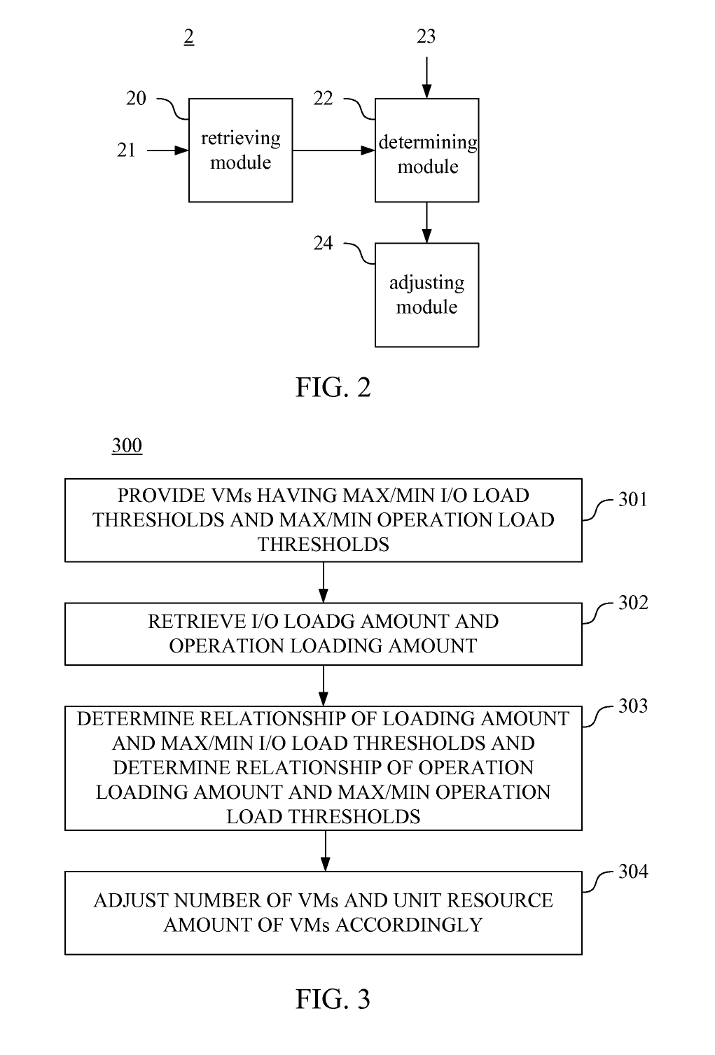

FIG. 2 is a block diagram of a device 2 for adjusting virtual resource according to an embodiment of the present disclosure. The device 2 comprises a retrieving module 20, a determining module 22 and an adjusting module 24. In an embodiment, the device 2 is disposed in the load balancer 10 for adjusting the number of the virtual machines 12 and the unit resource amount of the virtual machines 12. In other embodiments, the device 2 merely place a portion of its components in the load balancer 10 or is completely independent of the load balancer 10.

FIG. 3 is a flow chart of a method 300 for adjusting virtual resource according to an embodiment of the present disclosure. The method 300 can be used in the device 2 depicted in FIG. 2. The method 300 comprises the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 301, virtual machines 12 in the virtual system 1 are provided. The virtual machines 12 have a maximum I/O load threshold, a minimum I/O load threshold, a maximum operation load threshold and a minimum operation load threshold.

In step 302, the retrieving module 20 depicted in FIG. 2 retrieves an I/O loading amount and an operation loading amount of the total data loading amount of the virtual system 1. The total data loading amount is the amount of data processed by the virtual machines. In the present embodiment, the total data loading amount can be categorized into an I/O type data loading amount and an operational type data loading amount. The I/O type data loading amount comprises an amount of network data access and an amount of hard disk data access, and the operational type data loading amount comprises an amount of the data operation of a CPU (Central Processing Unit) and an amount of the data access of the memory.

In general, the processing of the I/O type data is restricted by the number of the virtual machines 12. The number of the I/O ports of the virtual machines 12 is less when the number of the virtual machines 12 is less. Accordingly, the processing of the I/O type data is slower when there are not enough ports due to fewer virtual machines 12. On the other hand, the processing of the operational type data is restricted by the unit resource amount of the virtual machines 12. When the virtual machines 12 have a larger amount of the central processing units or a larger amount of the capacity of the memory, the processing of the operational type data will be faster.

In an embodiment, the determining module 22 retrieves related thresholds 23 from the virtual machines 12 or from the setting of the user. The relationship of the I/O loading amount and the maximum I/O load threshold and the minimum I/O load threshold is determined by the determining module 22, and the relationship of the operation loading amount and the maximum operation load threshold and the minimum operation load threshold is determined by the determining module 22 in step 303. The maximum I/O load threshold and the minimum I/O load threshold are the upper limit and the lower limit of the amount of the I/O type data that can be processed by the virtual machine 12 respectively. The amount of the I/O type data is beyond the upper limit of the amount of data that can be processed by the virtual machines 12 if the I/O loading amount is larger than the maximum I/O load threshold. On the contrary, there are many unused resources of the virtual machines 12 if the I/O loading amount is smaller than the minimum I/O load threshold. Similarly, the amount of the operational type data is beyond the upper limit of the amount of the data that can be processed by the virtual machines 12 if the operation loading amount is larger than the maximum operation load threshold. On the contrary, there are many unused resources of the virtual machines 12 if the operation loading amount is smaller than the minimum operation load threshold.

The adjusting module 24 adjusts the number of the virtual machines 12 according to the relationship of the I/O loading amount and the maximum I/O load threshold and the minimum I/O load threshold and adjusts an unit resource amount of the virtual machines 12 according to the relationship of the operation loading amount and the maximum operation load threshold and the minimum operation load threshold in step 304.

In an embodiment, the adjusting module 24 can perform adjustment according to the I/O loading amount and the operation loading amount respectively. For example, when the determining module 22 determines that the I/O loading amount is larger than the maximum I/O load threshold, the adjusting module 24 increases the number of the virtual machines 12. When the determining module 22 determines that the operation loading amount is larger than the maximum operation load threshold, the adjusting module 24 increases the unit resource amount of the virtual machines 12. In other words, when the I/O loading amount is larger than the maximum I/O load threshold, the number of the virtual machines 12 is increased. The unit resources of the virtual machines 12 that can be adjusted may comprises central processing unit or memory capacity. In an embodiment, the number of the virtual machines 12 having the smallest unit resource amount is increased first. In another embodiment, the adjusting module can perform more efficient adjustment strategy by referring to both of the I/O loading amount and the operation loading amount.

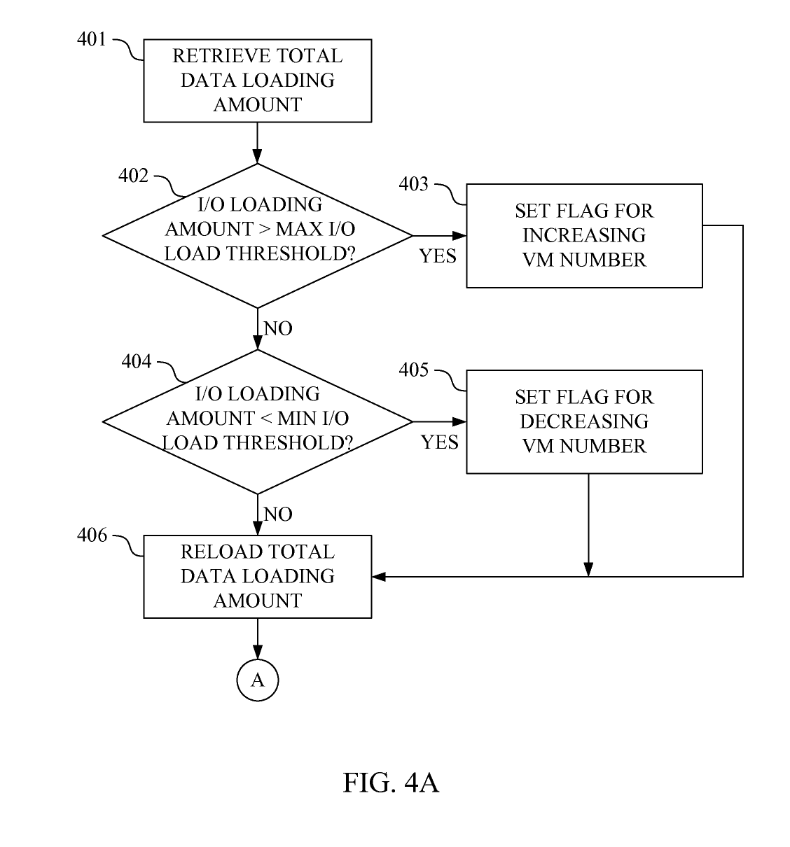

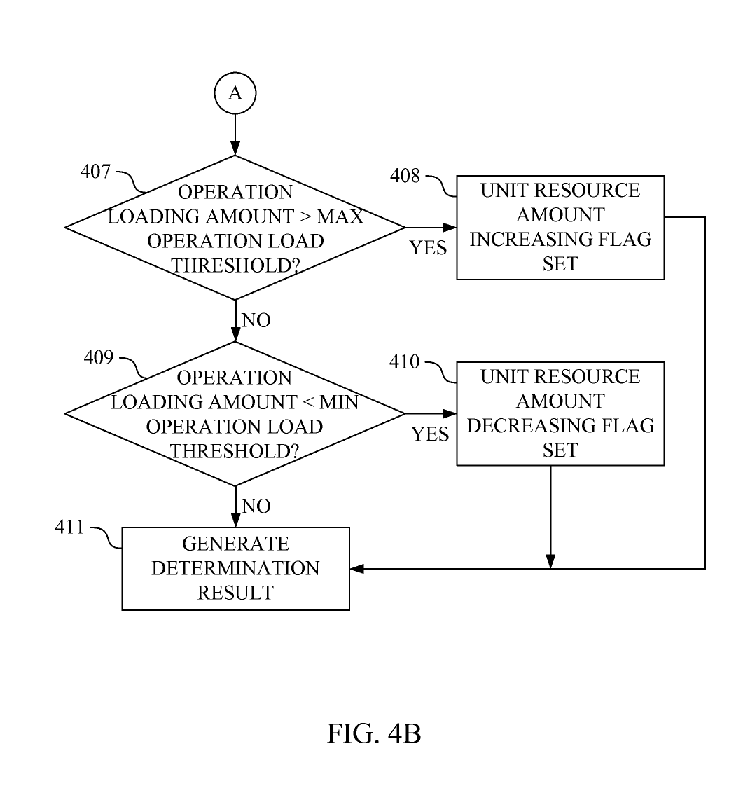

FIG. 4A and FIG. 4B are detail flow charts showing the process for determining the relationship of the I/O loading amount and the operation loading amount and the corresponding thresholds according to an embodiment of the present disclosure.

In step 401, the determining module 22 retrieves the total data loading amount 21 and determines whether the I/O loading amount is larger than the maximum I/O load threshold in step 402. When the I/O loading amount is larger than the maximum I/O load threshold, the determining module 22 sets a flag of increasing the number of virtual machines in step 403. When the I/O loading amount is not larger than the maximum I/O load threshold, the determining module 22 further determines whether the I/O loading amount is smaller than the minimum I/O load threshold in step 404. When the I/O loading amount is smaller than the minimum I/O load threshold, the determining module 22 sets a flag of decreasing the number of virtual machines in step 405. When the I/O loading amount is not smaller than the minimum I/O load threshold, the determining module 22 does not set any flag and the process proceeds to step 406 directly. It is noted that when step 403 or step 405 is finished, the process also proceeds to step 406 to reload the total data loading amount 21. If the determining module 22 determines that the number of the virtual machines 12 needs to be adjusted in the above process, the new number of the virtual machines will be taken into account when the total data loading amount 21 is reloaded. After reloading the total data loading amount 21, the process proceeds to point A to continue with the determination process depicted in FIG. 4B.

The process in FIG. 4B begins at point A to continue the process depicted in FIG. 4A. In step 407, the determining module 22 determines whether the operation loading amount is larger than the maximum operation load threshold. If the determining module 22 determines that the number of the virtual machines 12 needs to be adjusted in the above process, the maximum operation load threshold described herein is generated according to the new number of the virtual machines. For example, if the original number of the virtual machines 12 is two and the determining module 22 determines that the number of the virtual machines needs to be increased in the process in FIG. 4A, the maximum operation load threshold used in step 407 is the largest amount of operation that three virtual machines 12 can handle. Accordingly, the method can avoid the possibility of wasting the resources caused by simultaneously adjusting both the number of virtual machines and the amount of the unit resource when both of the I/O loading amount and the operation loading amount rise.

When the determining module 22 determines that the operation loading amount is larger than the maximum operation load threshold, the determining module 22 sets a flag of increasing unit resource amount in step 408. When the operation loading amount is not larger than the maximum operation load threshold, the determining module 22 further determines whether the operation loading amount is smaller than the minimum operation load threshold in step 409. When the operation loading amount is smaller than the minimum operation load threshold, the determining module 22 sets a flag of decreasing unit resource amount in step 410. When the operation loading amount is not smaller than the minimum operation load threshold, no flag is set by the determining module 22 and the process proceeds to step 411 directly. It is noted that when step 408 or step 410 is finished, the process also proceeds to step 411 to generate a determination result.

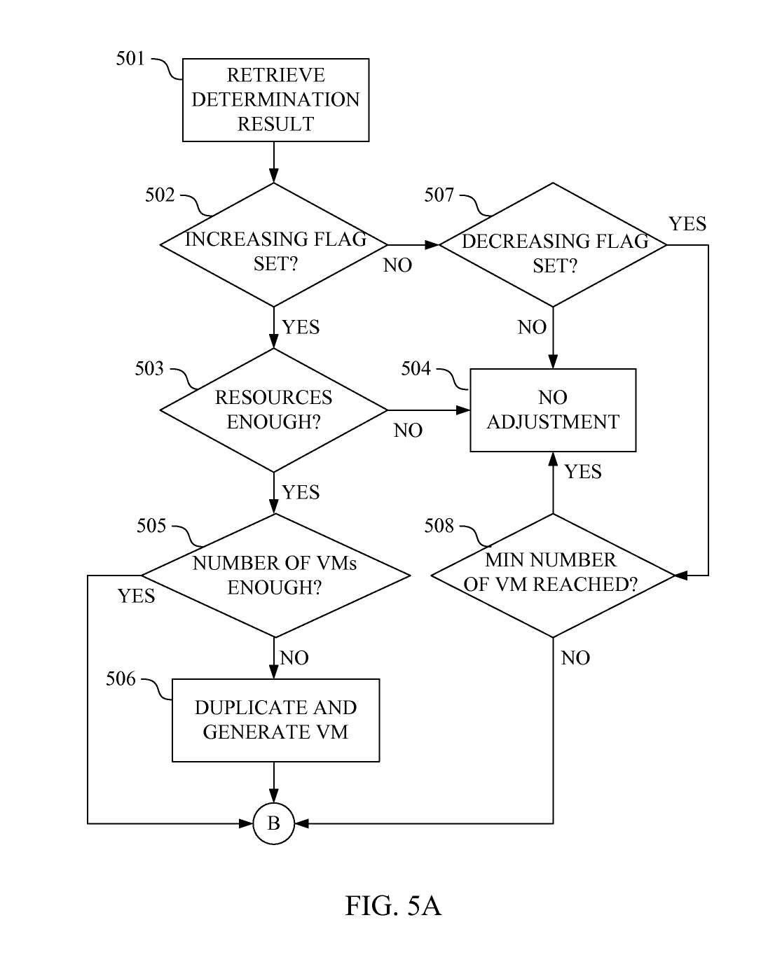

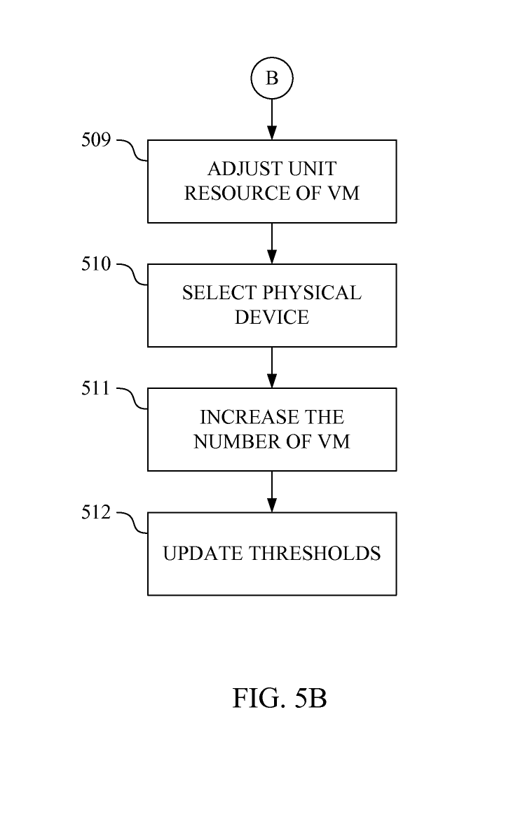

FIG. 5A and FIG. 5B are detail flow charts showing the process for adjusting the virtual machines according to an embodiment of the present disclosure. In step 501, the adjusting module 24 retrieves the determination result. In step 502, the adjusting module 24 determines whether the flag of increasing the number of virtual machine or the flag of increasing unit resource amount is set. If at least one of these flags is set, the adjusting module 24 determines whether the resources are enough for the adjustment in step 503. If the resources are not enough, the adjusting module 24 does not make adjustment. If the resources are enough, the adjusting module 24 further determines whether the number of the virtual machines is enough in step 505. When the number of the virtual machines needs to be increased, the adjusting module 24 duplicates one of the virtual machines in the system in step 506 to generate one new virtual machine and process proceeds to point B to continue with the process depicted in FIG. 5B. If the adjusting module 24 determines that the number of the virtual machines is enough, the process proceeds to point B directly to continue with the process depicted in FIG. 5B.

When the adjusting module 24 determines that the flag of increasing the number of virtual machine and the of increasing unit resource amount are not set, the adjusting module 24 determines whether the flag of decreasing the number of virtual machine or the flag of decreasing unit resource amount is set in step 507. If both of the flags are not set, the process proceeds back to step 504, where no adjustment is made by the adjusting module 24. If one of the flags is set, the adjusting module 24 determines whether the minimum number of the virtual machines is reached in step 508. If the minimum number of the virtual machines is reached, the process proceeds back to step 504, where the adjusting module 24 does not make adjustment. If the minimum number of the virtual machines is not reached, the process proceeds to point B to continue with the process depicted in FIG. 5B.

The process in FIG. 5B begins at point B. In step 509, the adjusting module 24 adjusts the unit resource of the virtual machines 12 according to the flags and selects the physical device in step 510 such that the physical resources demanded by the newly added virtual machines 12 are available in the step 511. In step 512, the virtual machines 12 updates the current thresholds to make the retrieving module 20 retrieve the latest maximum I/O load threshold, the latest minimum I/O load threshold, the latest maximum operation load threshold and the latest minimum operation load threshold. Consequently, the method and the device for adjusting the virtual resource used in the virtual system can perform adjustment on the number of the virtual machines and the unit resource amount of the virtual machines according to different types of data loading amounts. Further, the method and the device can perform efficient adjustment by referring different types of the resources, thereby avoiding over-adjustment.

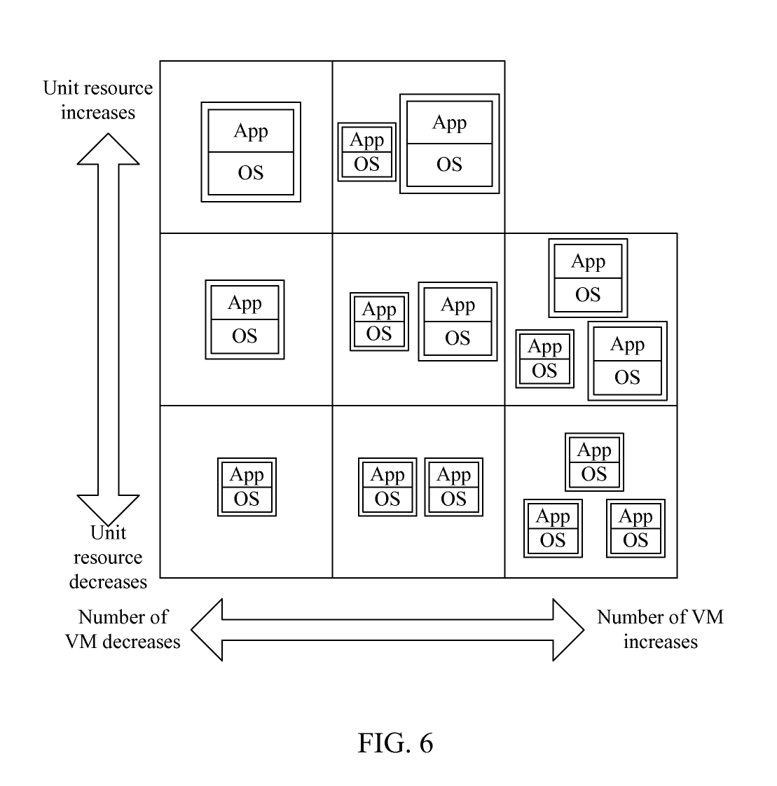

FIG. 6 is a graph showing the strategy of adjustment in the method according to an embodiment of the present disclosure. Each of the blocks labeled as APP/OS in FIG. 6 represents a virtual machine 12 depicted in FIG. 1. The blocks with larger area represent the virtual machines having larger unit resource.

Accordingly, the adjustment made along the vertical direction is used to adjust the number of the virtual machines and the adjustment made along the horizontal direction is used to adjust the amount of the unit resource of the virtual machines. In an embodiment, when there are two or more than two virtual machines 12 in the virtual system 1 and the I/O loading amount of the virtual system 1 is larger than the maximum I/O load threshold of the virtual machines 12, the main adjustment strategy is to adjust the number of the virtual machines since the I/O ports of the virtual machines are not enough. The adjustment of the unit resource of the virtual machines is not taken into consideration in the first place. Hence, the adjusting module 24 can increase the number of the virtual machines 12 that have the smallest unit resource first.

In an embodiment, when there are two or more than two virtual machines 12 in the virtual system 1 and the operation loading amount of the virtual system 1 is larger than the maximum operation load threshold of the virtual machines 12, the main adjustment strategy is to adjust the unit resource amount of the virtual machines that have the largest unit resource. Hence, by increasing the unit resource amount of the virtual machines that have the largest unit resource first, the resource demanded by the operation data loading can be satisfied.

In an embodiment, when there are two or more than two virtual machines 12 in the virtual system 1 and the I/O loading amount of the virtual system 1 is smaller than the minimum I/O load threshold of the virtual machines 12, it is possible to decrease the resource too much if the virtual machines 12 having larger unit resource amount are turned off. Accordingly, the adjusting module 24 can decrease the number of the virtual machines 12 having the smallest unit resource amount first.

In an embodiment, when there are two or more than two virtual machines 12 in the virtual system 1 and the operation loading amount of the virtual system 1 is smaller than the minimum operation load threshold of the virtual machines 12, it is possible to decrease the resource too much if the unit resource amount of the virtual machines 12 having larger unit resource amount are decreased. Accordingly, the adjusting module 24 can decrease the unit resource amount of the virtual machines 12 having the smallest unit resource amount first.

Consequently, the method and the device for adjusting the virtual resource used in the virtual system can perform adjustment on the number of the virtual machines and the unit resource according to different types of data loading. Further, the method and the device can perform efficient adjustment by taking the change in one of the resources into consideration to adjust other kinds of resource for avoiding over-adjustment.

In another embodiment, a computer readable storage medium to store a computer program to execute the method for adjusting virtual resource used in the virtual system described above is provided. The process of the method is the same as the process described above. No further detail is discussed here.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for adjusting a virtual resource used in a virtual system, the method comprising:
providing at least one virtual machine in the virtual system, the at least one virtual machine having a maximum I/O (Input/Output) load threshold, a minimum I/O load threshold, a maximum operation load threshold and a minimum operation load threshold;
retrieving an I/O loading amount and an operation loading amount from a total data loading amount of the virtual system;
determining a relationship of the I/O loading amount and the maximum I/O load threshold and the minimum I/O load threshold and determining a relationship of the operation loading amount and the maximum operation load threshold and the minimum operation load threshold;
adjusting a number of the at least one virtual machine according to the relationship of the I/O loading amount and the maximum I/O load threshold and the minimum I/O load threshold, and adjusting an unit resource amount of the at least one virtual machine according to the relationship of the operation loading amount and the maximum operation load threshold and the minimum operation load threshold.

2. The method of claim 1, further comprising:
increasing the number of the at least one virtual machine when the I/O loading amount is larger than the maximum I/O load threshold.

3. The method of claim 2, wherein the step of increasing the number of the at least one virtual machine is to increase the number of the at least one virtual machine having the smallest unit resource amount.

4. The method of claim 2, wherein when the I/O loading amount is larger than the maximum I/O load threshold such that the number of the at least one virtual machine is increased, the step of determining the relationship of the operation loading amount and the maximum operation load threshold and the minimum operation load threshold further comprises:
determining whether the operation loading amount is larger than the maximum operation load threshold of the at least one virtual machine of which the number has been increased;
when the operation loading amount is larger than the maximum operation load threshold of the at least one virtual machine of which the number has been increased, increasing the unit resource amount of one of the at least one virtual machine of which the number has been increased;
determining whether the operation loading amount is smaller than the minimum operation load threshold of the at least one virtual machine of which the number has been increased; and
when the operation loading amount is larger than the maximum operation load threshold of the at least one virtual machine of which the number has been increased, the unit resource amount of one of the at least one virtual machine of which the number has been increased is decreased.

5. The method of claim 4, wherein the step of increasing the unit resource amount of one of the at least one virtual machine of which the number has been increased is to increase the unit resource amount of one of the at least one virtual machine of which the number has been increased that has the largest unit resource amount.

6. The method of claim 1, further comprising:
decreasing the number of the at least one virtual machine when the I/O loading amount is smaller than the minimum I/O load threshold.

7. The method of claim 6, wherein the step of decreasing the number of the at least one virtual machine when the I/O loading amount is smaller than the minimum I/O load threshold is to decrease the number of the at least one virtual machine having the smallest unit resource amount.

8. The method of claim 6, wherein when the I/O loading amount is smaller than the minimum I/O load threshold such that the number of the at least one virtual machine is decreased, the step of determining the relationship of the operation loading amount and the maximum operation load threshold and the minimum operation load threshold further comprises:
determining whether the operation loading amount is smaller than the minimum operation load threshold of the at least one virtual machine of which the number has been decreased;
when the operation loading amount is smaller than the minimum operation load threshold of the at least one virtual machine having the decreased amount, decreasing the unit resource amount of one of the at least one virtual machine of which the number has been decreased;
determining whether the operation loading amount is larger than the maximum operation load threshold of the at least one virtual machine of which the number has been decreased; and
when the operation loading amount is larger than the maximum operation load threshold of the at least one virtual machine of which the number has been decreased, the unit resource amount of one of the at least one virtual machine of which the number has been decreased is increased.

9. The method of claim 8, wherein the step of decreasing the unit resource amount of one of the at least one virtual machine of which the number has been decreased is to decrease the unit resource amount of one of the at least one virtual machine that has the smallest unit resource amount after the number of the at least one virtual machine has been decreased.

10. The method of claim 1, wherein the I/O loading amount comprises a network access amount and a hard disk access amount.

11. The method of claim 1, wherein the operation loading amount comprises a CPU (central processing unit) operation amount and a memory access amount.

12. A device for adjusting virtual resource used in a virtual system having at least one virtual machine, wherein the device comprises:
a retrieving module for retrieving an I/O loading amount and an operation loading amount of a total data loading amount of the virtual system;
a determining module to determine the relation of the I/O loading amount and a maximum I/O load threshold and a minimum I/O load threshold of the at least one virtual machine and determining the relation of the operation loading amount and a maximum operation load threshold and a minimum operation load threshold of the at least one virtual machine; and
an adjusting module to adjust the number of the at least one virtual machine according to the relation of the I/O loading amount and the maximum I/O load threshold and the minimum I/O load threshold and to adjust an unit resource amount of the virtual machine according to the relation of the operation loading amount and the maximum operation load threshold and the minimum operation load threshold.

13. The device of claim 12, wherein when the I/O loading amount is larger than the maximum I/O load threshold, the adjusting module increases the number of the at least one virtual machine.

14. The device of claim 13, wherein adjusting module increases the number of the virtual machine having the smallest unit resource amount.

15. The device of claim 13, wherein when the I/O loading amount is larger than the maximum I/O load threshold such that the number of the at least one virtual machine is increased, the determining module further determines whether the operation loading amount is larger than the maximum operation load threshold of the at least one virtual machine of which the number is increased; and the adjusting module increases the unit resource amount of one of the at least one virtual machines of which the number has been increased when the operation loading amount is larger than the maximum operation load threshold of the at least one virtual machines of which the number has been increased; and
the determining module further determines whether the operation loading amount is smaller than the minimum operation load threshold of the at least one virtual machine of which the number has been increased, and the adjusting module decreases the unit resource amount of one of the at least one virtual machine of which the number has been increased when the operation loading amount is smaller than the minimum operation load threshold of the at least one virtual machine of which the number has been increased.

16. The device of claim 15, wherein the adjusting module increases the unit resource amount of one of the at least one virtual machine of which the number has been increased that has the largest unit resource amount.

17. The device of claim 12, wherein the adjusting module decreases the number of the at least one virtual machine when the I/O loading amount is smaller than the minimum I/O load threshold.

18. The device of claim 17, wherein the adjusting module decreases the number of the at least one virtual machine having the smallest unit resource amount.

19. The device of claim 17, wherein when the I/O loading amount is smaller than the minimum I/O load threshold such that the number of the at least one virtual machine is decreased, the determining module further determines whether the operation loading amount is smaller than the minimum operation load threshold of the at least one virtual machine of which the number is decreased; and the adjusting module decreases the unit resource amount of one of the at least one virtual machine of which the number is decreased when the operation loading amount is smaller than the minimum operation load threshold of the at least one virtual machine of which the number is decreased; and
the determining module further determines whether the operation loading amount is larger than the maximum operation load threshold of the at least one virtual machine of which the number is decreased; and the adjusting module increases the unit resource amount of one of the at least one virtual machine of which the number is decreased when the operation loading amount is larger than the maximum operation load threshold of the at least one virtual machine of which the number is decreased.

20. The device of claim 19, wherein the adjusting module decreases the unit resource amount of one of the at least one virtual machine that has the smallest unit resource amount after the number of the at least one virtual machine has been decreased.

21. The device of claim 12, wherein the I/O loading amount comprises a network access amount and a hard disk access amount.

22. The device of claim 12, wherein the operation loading amount comprises a central processing unit operation amount and a memory access amount.

23. A computer readable storage medium to store a computer program to execute a method for adjusting virtual resource used in a virtual system, the method comprises the steps of:
providing at least one virtual machine in the virtual system having a maximum I/O load threshold, a minimum I/O load threshold, a maximum operation load threshold and a minimum operation load threshold;
retrieving an I/O loading amount and an operation loading amount of the total data loading amount of the virtual system;
determining a relationship of the I/O loading amount and the maximum I/O load threshold and the minimum I/O load threshold, and determining a relationship of the operation loading amount and the maximum operation load threshold and the minimum operation load threshold;
adjusting the number of the at least one virtual machine according to the relationship of the I/O loading amount and the maximum I/O load threshold and the minimum I/O load threshold and adjusting an unit resource amount of the at least one virtual machine according to the relationship of the operation loading amount and the maximum operation load threshold and the minimum operation load threshold.
